(19) United States
(12) Patent Application Publication
(10) Pub. No.: US 2024/0031742 A1
(43) Pub. Date: Jan. 25, 2024

(54) COMPACT SPEAKER INCLUDING A WEDGE-SHAPED MAGNET AND A SURROUND HAVING ASYMMETRICAL STIFFNESS

(71) Applicant: Meta Platforms Technologies, LLC, Menlo Park, CA (US)

(72) Inventors: Minoo Kabir, Santa Clara, CA (US); Ulrik Skov, Saratoga, CA (US)

(21) Appl. No.: 18/085,313

(22) Filed: Dec. 20, 2022

Related U.S. Application Data
(60) Provisional application No. 63/391,249, filed on Jul. 21, 2022.

(51) Int. Cl. H04R 9/04; H04R 7/18

(52) U.S. Cl. CPC H04R 9/046; H04R 7/18; H04R 2400/11

(57) ABSTRACT

A speaker includes a magnet having a wedge-shape, so the magnet has different widths at different locations. One or more voice coils are coupled to a diaphragm that is proximate to the magnet. As the magnet has different widths at different locations, different locations of the magnet provide a different magnetic field strength. To compensate for variances in movement of the diaphragm from the varying magnetic field strength of the magnet, a surround coupled to the diaphragm has an asymmetric stiffness. The surround has a higher stiffness proximate to locations of the magnet where the magnetic field is stronger and a lower stiffness proximate to locations of the magnet where the magnetic field is weaker.

### CROSS-REFERENCE TO RELATED APPLICATIONS

This application claims the benefit of U.S. Provisional Application No. 63/391,249, filed Jul. 21, 2022, which is incorporated by reference in its entirety.

### FIELD OF THE INVENTION

This disclosure relates generally to artificial reality systems, and more specifically to speakers for artificial reality systems.

### BACKGROUND

Artificial reality systems, or mixed reality systems, often provide visual and audio content to a user. Many artificial reality systems use a headset or a head mounted display to display visual content to a user. Additionally, portions of a headset or head mounted display include speakers that play audio content.

As headsets or head mounted displays become smaller, the space available for components decreases. Additionally, form factors for headsets or head mounted displays have made these devices more comfortable for users, but these form factors have resulted in unconventional shapes or sizes for positioning components within a head mounted display or a headset. As an example, headsets including a frame with temples configured to rest on a user's ears make the headsets more comfortable for the user, but provide limited space for including components, such as speakers in portions of the frame. For example, many designs for temples taper, causing the area within the temple to decrease along a length of the temple, limiting space for including one or more components in the temple.

Many headsets designed as a frame including temples include speakers in the temples. This configuration allows the speakers to be placed close to a user's ear. While this positioning increases perception of audio content to the user via the speakers, the temples have limited space for including speakers. Additionally, tapering of the temples in various designs limits area within the temples for components. Thus, the size of a conventional rectangular speaker or round speaker in a temple of a frame design needs to be reduced considerably to fit inside the asymmetric (tapered) shape of the temple arm. Smaller speakers result in reduced audio output, impairing presentation of audio content to users wearing such a headset.

### SUMMARY

A speaker includes a magnet providing a magnetic field. One or more voice coils are coupled to a diaphragm of the speaker that is proximate to the magnet. A voice coil generates a magnetic field in response to receiving a signal. Reactions between the magnetic field of the magnet and the magnetic field of the voice coil cause the diaphragm to move relative to the magnet. For example, the magnetic field of the magnet and the magnetic field of the voice coil cause the diaphragm to move towards or away from the magnet. Movement of the diaphragm creates sound waves that provide audio to a user. In limited areas, such as in a frame of a headset, an area available for movement of a diaphragm is limited, while an amount of air available to be displaced by movement of the diaphragm is also limited. This reduces audio output by a conventional speaker when operating in a limited area or increases an amount of power consumed by a conventional speaker when operating in a limited area.

To provide improved audio output while reducing dimensions of an audio device, an apparatus includes a diaphragm coupled to a voice coil. A magnet is proximate to the diaphragm, with the magnet having a first width at a first end and a second width at a second end, where the first width is larger than the second width. As the differing widths of the magnet result in a different magnetic field strength at different locations on the magnet, a surround is coupled to the diaphragm, with the surround having a stiffness varying along a length of the surround from a first stiffness proximate to the first end of the magnet to a second stiffness proximate to the second end of the magnet. In various embodiments, the surround couples the diaphragm to a portion of a frame including the magnet and the diaphragm. The first stiffness of the surround is greater than the second stiffness of the surround.

Additionally, a headset includes a frame and one or more display elements coupled to the frame, with each display element configured to generate image light. A speaker is included in a portion of the frame, with the speaker including a diaphragm coupled to a voice coil and a magnet proximate to the diaphragm. The magnet has first width at a first end and a second width at a second end, where the first width is larger than the second width. The speaker further includes a surround coupled to the diaphragm that couples the diaphragm to the portion of the frame. The surround has a stiffness varying along a length of the surround from a first stiffness proximate to the first end of the magnet to a second stiffness proximate to the second end of the magnet, with the first stiffness greater than the second stiffness.

### BRIEF DESCRIPTION OF THE DRAWINGS

FIG. 1A is a perspective view of a headset implemented as an eyewear device, in accordance with one or more embodiments.

FIG. 1B is a perspective view of a headset implemented as a head-mounted display, in accordance with one or more embodiments.

FIG. 2 is a block diagram of an audio system, in accordance with one or more embodiments.

FIG. 3 is a side view of a device including a speaker and an additional speaker, in accordance with one or more embodiments.

FIG. 4 is a side view of one embodiment of a magnet having a wedge-shape, in accordance with one or more embodiments.

FIG. 5 is an example perspective view of a surround with a varying cross-section, in accordance with one or more embodiments.

FIG. 6 is an example of movement of a diaphragm relative to a magnet at different locations along a length of a surround, in accordance with one or more embodiments.

FIG. 7 is an alternative example of movement of a diaphragm relative to a magnet at different locations along a length of a surround, in accordance with one or more embodiments.

FIG. 8 is an isometric cross-section of a portion of a frame of a headset including an audio device having a magnet with a wedge shape, in accordance with one or more embodiments.

FIG. 9 is a system that includes a headset, in accordance with one or more embodiments.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

A speaker includes a magnet providing a magnetic field. One or more voice coils are coupled to a diaphragm that is proximate to the magnet, a voice coil generates a magnetic field in response to receiving a signal. The magnetic field of the magnet and the magnetic field of the voice coil cause the diaphragm to move relative to the magnet. For example, a magnetic field generated by the voice coil is repelled by the magnetic field of the magnet, causing the diaphragm to move away from the magnet. As another example, the magnetic field generated by the voice coil is attracted to the magnetic field of the magnet, causing the diaphragm to move towards the magnet. Movement of the diaphragm creates sound waves that provide audio to a user. In limited areas, such as in a frame of a headset, an area available for movement of a speaker diaphragm and an amount of air to be displaced by movement of the diaphragm is limited.

To improve performance of a speaker in a limited area, the speaker includes a wedge-shaped magnet, so the magnet has different widths at different locations. For example, a first end of the magnet has a maximum width, with the magnet tapering to a minimum width at a second end. While this allows the magnet to be more space efficient, the changing width of the magnet changes a strength of the magnetic field at different locations of the magnet. To compensate for the varying strength of the magnetic field of the magnet on different portions of the diaphragm, a surround coupled to an edge of the diaphragm has a variable stiffness along the length of the surround. Different locations along a length of the surround have a different stiffness, so different locations along the length of the surround provide different resistance to movement by different portions of the diaphragm. For example, the surround has a higher stiffness proximate to locations of the magnet where the magnetic field is stronger (e.g., where the magnet is wider) to limit an amount by which the diaphragm moves relative to the magnet, while the surround has lower stiffness proximate to locations of the magnet where the magnetic field is weaker (e.g., where the magnet is narrower), providing less resistance to movement for portions of the diaphragm. Having an asymmetrical stiffness along its lengths allows the surround to restrict movement of the diaphragm where the magnetic field of the magnet is stronger and to facilitate movement of the diaphragm where the magnetic field of the magnet is weaker. This allows a force factor of the speaker to be increased while reducing power consumption of the speaker to cause different displacements of the diaphragm relative to the magnet.

Embodiments of the invention may include or be implemented in conjunction with an artificial reality system. Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured (e.g., real-world) content. The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to create content in an artificial reality and/or are otherwise used in an artificial reality. The artificial reality system that provides the artificial reality content may be implemented on various platforms, including a wearable device (e.g., headset) connected to a host computer system, a standalone wearable device (e.g., headset), a mobile device or computing system, or any other hardware platform capable of providing artificial reality content to one or more viewers.

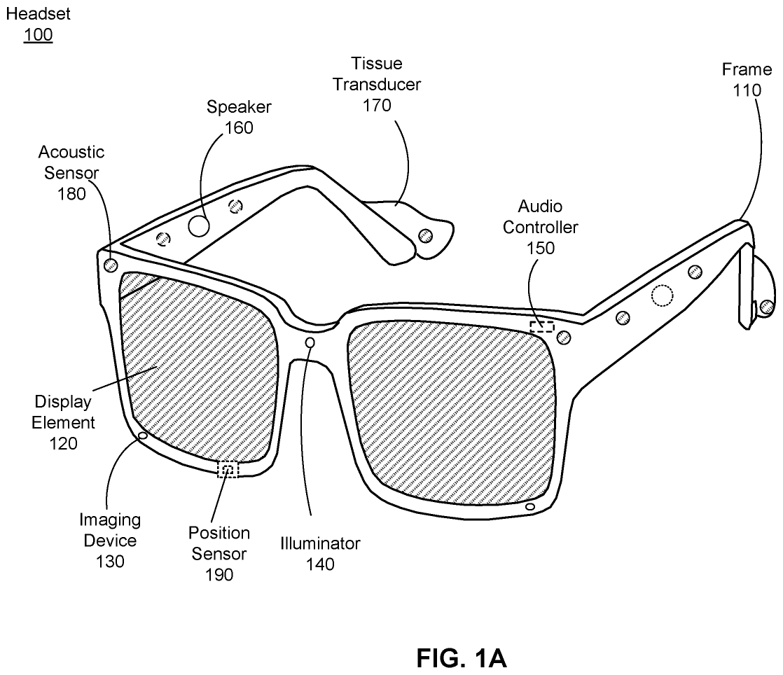

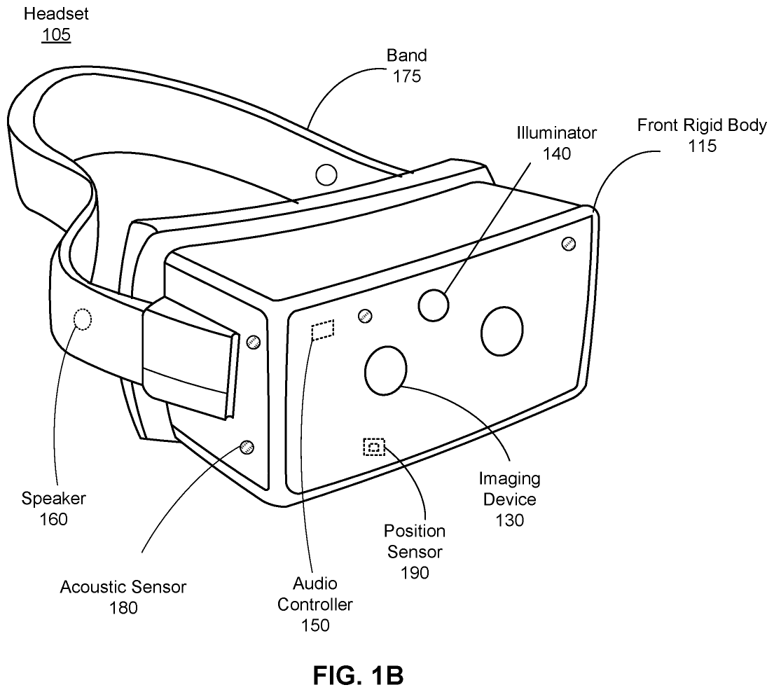

FIG. 1A is a perspective view of a headset 100 implemented as an eyewear device, in accordance with one or more embodiments. In some embodiments, the eyewear device is a near eye display (NED). In general, the headset 100 may be worn on the face of a user such that content (e.g., media content) is presented using a display assembly and/or an audio system. However, the headset 100 may also be used such that media content is presented to a user in a different manner. Examples of media content presented by the headset 100 include one or more images, video, audio, or some combination thereof. The headset 100 includes a frame, and may include, among other components, a display assembly including one or more display elements 120, a depth camera assembly (DCA), an audio system, and a position sensor 190. While FIG. 1A illustrates the components of the headset 100 in example locations on the headset 100, the components may be located elsewhere on the headset 100, on a peripheral device paired with the headset 100, or some combination thereof. Similarly, there may be more or fewer components on the headset 100 than what is shown in FIG. 1A.

The frame 110 holds the other components of the headset 100. The frame 110 includes a front part that holds the one or more display elements 120 and end pieces (e.g., temples) to attach to a head of the user. The front part of the frame 110 bridges the top of a nose of the user. The length of the end pieces may be adjustable (e.g., adjustable temple length) to fit different users. The end pieces may also include a portion that curls behind the ear of the user (e.g., temple tip, earpiece).

The one or more display elements 120 provide light to a user wearing the headset 100. As illustrated the headset includes a display element 120 for each eye of a user. In some embodiments, a display element 120 generates image light that is provided to an eyebox of the headset 100. The eyebox is a location in space that an eye of user occupies while wearing the headset 100. For example, a display element 120 may be a waveguide display. A waveguide display includes a light source (e.g., a two-dimensional source, one or more line sources, one or more point sources, etc.) and one or more waveguides. Light from the light source is in-coupled into the one or more waveguides which outputs the light in a manner such that there is pupil replication in an eyebox of the headset 100. In-coupling and/or outcoupling of light from the one or more waveguides may be done using one or more diffraction gratings. In some embodiments, the waveguide display includes a scanning element (e.g., waveguide, mirror, etc.) that scans light from the light source as it is in-coupled into the one or more waveguides. Note that in some embodiments, one or both of the display elements 120 are opaque and do not transmit light from a local area around the headset 100. The local area is the area surrounding the headset 100. For example, the local area may be a room that a user wearing the headset 100 is inside, or the user wearing the headset 100 may be outside and the local area is an outside area. In this context, the headset 100 generates VR content. Alternatively, in some embodiments, one or both of the display elements 120 are at least partially transparent, such that light from the local area may be combined with light from the one or more display elements to produce AR and/or MR content.

In some embodiments, a display element 120 does not generate image light, and instead is a lens that transmits light from the local area to the eyebox. For example, one or both of the display elements 120 may be a lens without correction (non-prescription) or a prescription lens (e.g., single vision, bifocal and trifocal, or progressive) to help correct for defects in a user's eyesight. In some embodiments, the display element 120 may be polarized and/or tinted to protect the user's eyes from the sun.

In some embodiments, the display element 120 may include an additional optics block (not shown). The optics block may include one or more optical elements (e.g., lens, Fresnel lens, etc.) that direct light from the display element 120 to the eyebox. The optics block may, e.g., correct for aberrations in some or all of the image content, magnify some or all of the image, or some combination thereof.

The DCA determines depth information for a portion of a local area surrounding the headset 100. The DCA includes one or more imaging devices 130 and a DCA controller (not shown in FIG. 1A), and may also include an illuminator 140. In some embodiments, the illuminator 140 illuminates a portion of the local area with light. The light may be, e.g., structured light (e.g., dot pattern, bars, etc.) in the infrared (IR), IR flash for time-of-flight, etc. In some embodiments, the one or more imaging devices 130 capture images of the portion of the local area that include the light from the illuminator 140. As illustrated, FIG. 1A shows a single illuminator 140 and two imaging devices 130. In alternate embodiments, there is no illuminator 140 and at least two imaging devices 130.

The DCA controller computes depth information for the portion of the local area using the captured images and one or more depth determination techniques. The depth determination technique may be, e.g., direct time-of-flight (ToF) depth sensing, indirect ToF depth sensing, structured light, passive stereo analysis, active stereo analysis (uses texture added to the scene by light from the illuminator 140), some other technique to determine depth of a scene, or some combination thereof.

The audio system provides audio content. The audio system includes a transducer array, a sensor array, and an audio controller 150. However, in other embodiments, the audio system may include different and/or additional components. Similarly, in some cases, functionality described with reference to the components of the audio system can be distributed among the components in a different manner than is described here. For example, some or all of the functions of the controller may be performed by a remote server.

The transducer array presents sound to user. The transducer array includes a plurality of transducers. A transducer may be a speaker 160 or a tissue transducer 170 (e.g., a bone conduction transducer or a cartilage conduction transducer). Although the speakers 160 are shown exterior to the frame 110, the speakers 160 may be enclosed in the frame 110. In some embodiments, instead of individual speakers for each ear, the headset 100 includes a speaker array comprising multiple speakers integrated into the frame 110 to improve directionality of presented audio content. The tissue transducer 170 couples to the head of the user and directly vibrates tissue (e.g., bone or cartilage) of the user to generate sound. The number and/or locations of transducers may be different from what is shown in FIG. 1A.

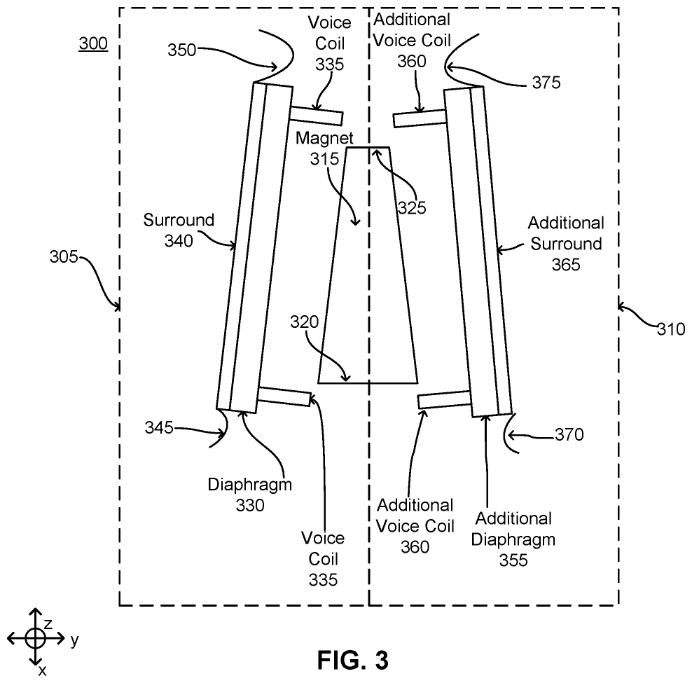

To more efficiently use space available in the frame 110, in various embodiments, a speaker 160 included in the frame 110 includes a wedge-shaped magnet and a surround having an asymmetrical stiffness along at least one dimension. The wedge-shaped magnet allows the speaker 160 to provide increased efficiency when included in smaller areas, such as within an end piece of the frame 110. For example, an end piece of the frame is tapered, with a portion of the end piece farther from a display element 120 narrower than another portion of the end piece nearer to the display element 120. This form factor for an end piece of the frame 110 reduces efficiency of conventional speaker designs including rectangular magnets. As further described below in conjunction with FIGS. 3-8, including a wedge-shaped magnet in a speaker 160 improves (e.g., optimizes) use of area in the frame 110 by accounting for tapering of portions of the frame 110 including the speaker 160. To compensate for variations in strength of the magnetic field of the magnet caused by the differing width of the wedge-shaped magnet, the speaker includes a surround having an asymmetrical stiffness along a length of the surround. The stiffness of the surround is greater near locations of the magnet that are wider, while the stiffness of the surround is lower near locations of the magnet that are narrower. This varying stiffness of the surround balances movement of a diaphragm of the speaker 160 across different widths of the wedge-shaped magnet, which increases volume displacement of the diaphragm, as further described below in conjunction with FIGS. 3-8.

The sensor array detects sounds within the local area of the headset 100. The sensor array includes a plurality of acoustic sensors 180. An acoustic sensor 180 captures sounds emitted from one or more sound sources in the local area (e.g., a room). Each acoustic sensor is configured to detect sound and convert the detected sound into an electronic format (analog or digital). The acoustic sensors 180 may be acoustic wave sensors, microphones, sound transducers, or similar sensors that are suitable for detecting sounds.

In some embodiments, one or more acoustic sensors 180 may be placed in an ear canal of each ear (e.g., acting as binaural microphones). In some embodiments, the acoustic sensors 180 may be placed on an exterior surface of the headset 100, placed on an interior surface of the headset 100, separate from the headset 100 (e.g., part of some other device), or some combination thereof. The number and/or locations of acoustic sensors 180 may be different from what is shown in FIG. 1A. For example, the number of acoustic detection locations may be increased to increase the amount of audio information collected and the sensitivity and/or accuracy of the information. The acoustic detection locations may be oriented such that the microphone is able to detect sounds in a wide range of directions surrounding the user wearing the headset 100.

The audio controller 150 processes information from the sensor array that describes sounds detected by the sensor array. The audio controller 150 may comprise a processor and a computer-readable storage medium. The audio controller 150 may be configured to generate direction of arrival (DOA) estimates, generate acoustic transfer functions (e.g., array transfer functions and/or head-related transfer functions), track the location of sound sources, form beams in the direction of sound sources, classify sound sources, generate sound filters for the speakers 160, or some combination thereof.

The position sensor 190 generates one or more measurement signals in response to motion of the headset 100. The position sensor 190 may be located on a portion of the frame 110 of the headset 100. The position sensor 190 may include an inertial measurement unit (IMU). Examples of position sensor 190 include: one or more accelerometers, one or more gyroscopes, one or more magnetometers, another suitable type of sensor that detects motion, a type of sensor used for error correction of the IMU, or some combination thereof. The position sensor 190 may be located external to the IMU, internal to the IMU, or some combination thereof.

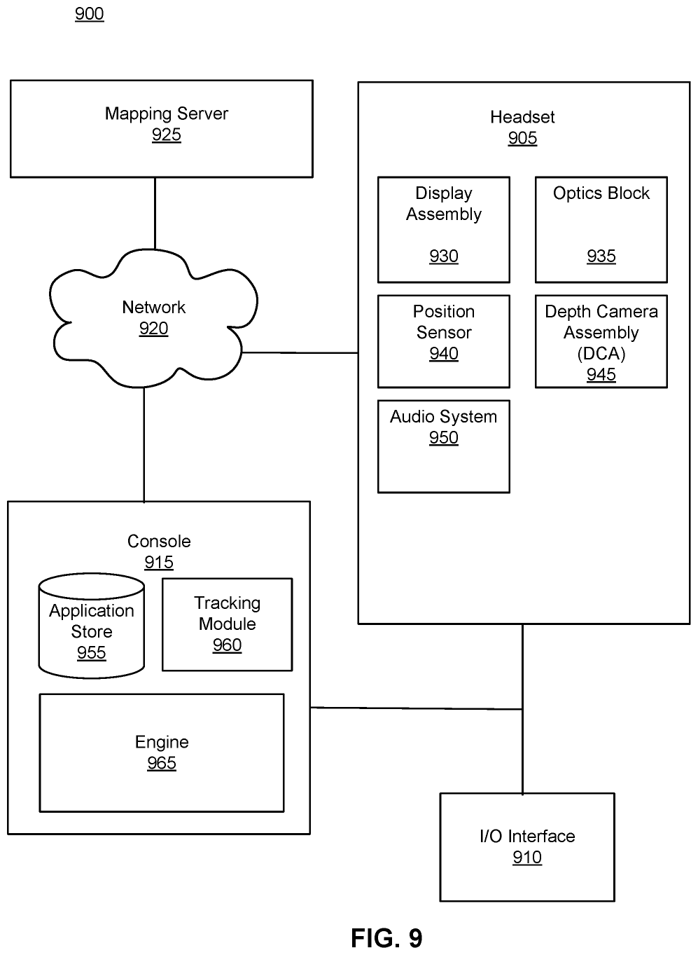

In some embodiments, the headset 100 may provide for simultaneous localization and mapping (SLAM) for a position of the headset 100 and updating of a model of the local area. For example, the headset 100 may include a passive camera assembly (PCA) that generates color image data. The PCA may include one or more RGB cameras that capture images of some or all of the local area. In some embodiments, some or all of the imaging devices 130 of the DCA may also function as the PCA. The images captured by the PCA and the depth information determined by the DCA may be used to determine parameters of the local area, generate a model of the local area, update a model of the local area, or some combination thereof. Furthermore, the position sensor 190 tracks the position (e.g., location and pose) of the headset 100 within the room. Additional details regarding the components of the headset 100 are discussed below in connection with FIG. 9.

FIG. 1B is a perspective view of a headset 105 implemented as a HMD, in accordance with one or more embodiments. In embodiments that describe an AR system and/or a MR system, portions of a front side of the HMD are at least partially transparent in the visible band (˜380 nm to 750 nm), and portions of the HMD that are between the front side of the HMD and an eye of the user are at least partially transparent (e.g., a partially transparent electronic display). The HMD includes a front rigid body 115 and a band 175. The headset 105 includes many of the same components described above with reference to FIG. 1A, but modified to integrate with the HMD form factor. For example, the HMD includes a display assembly, a DCA, an audio system, and a position sensor 190. FIG. 1B shows the illuminator 140, a plurality of the speakers 160, a plurality of the imaging devices 130, a plurality of acoustic sensors 180, and the position sensor 190. The speakers 160 may be located in various locations, such as coupled to the band 175 (as shown), coupled to front rigid body 115, or may be configured to be inserted within the ear canal of a user.

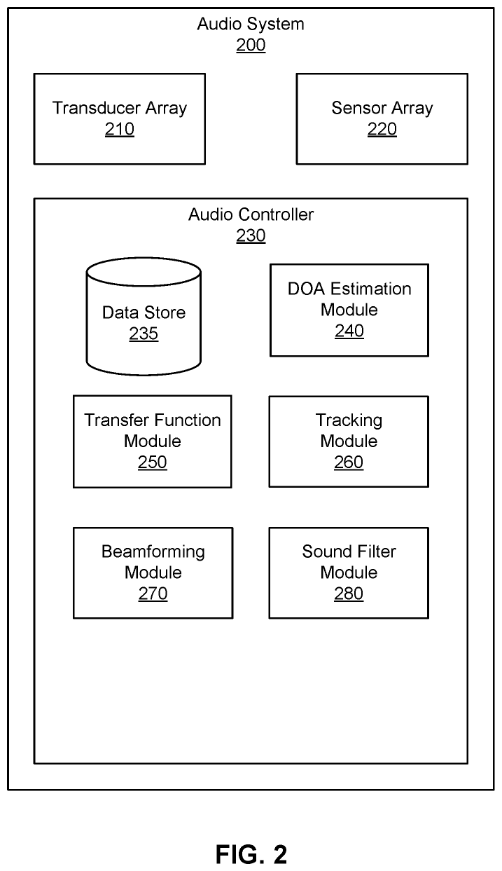

FIG. 2 is a block diagram of an audio system 200, in accordance with one or more embodiments. The audio system in FIG. 1A or FIG. 1B may be an embodiment of the audio system 200. The audio system 200 generates one or more acoustic transfer functions for a user. The audio system 200 may then use the one or more acoustic transfer functions to generate audio content for the user. In the embodiment of FIG. 2, the audio system 200 includes a transducer array 210, a sensor array 220, and an audio controller 230. Some embodiments of the audio system 200 have different components than those described here. Similarly, in some cases, functions can be distributed among the components in a different manner than is described here.

The transducer array 210 is configured to present audio content. The transducer array 210 includes a plurality of transducers. A transducer is a device that provides audio content. A transducer may be, e.g., a speaker (e.g., the speaker 160), a tissue transducer (e.g., the tissue transducer 170), some other device that provides audio content, or some combination thereof. A tissue transducer may be configured to function as a bone conduction transducer or a cartilage conduction transducer. The transducer array 210 may present audio content via air conduction (e.g., via one or more speakers), via bone conduction (via one or more bone conduction transducer), via cartilage conduction audio system (via one or more cartilage conduction transducers), or some combination thereof. In some embodiments, the transducer array 210 may include one or more transducers to cover different parts of a frequency range. For example, a piezoelectric transducer may be used to cover a first part of a frequency range and a moving coil transducer may be used to cover a second part of a frequency range.

The bone conduction transducers generate acoustic pressure waves by vibrating bone/tissue in the user's head. A bone conduction transducer may be coupled to a portion of a headset, and may be configured to be behind the auricle coupled to a portion of the user's skull. The bone conduction transducer receives vibration instructions from the audio controller 230, and vibrates a portion of the user's skull based on the received instructions. The vibrations from the bone conduction transducer generate a tissue-borne acoustic pressure wave that propagates toward the user's cochlea, bypassing the eardrum.

The cartilage conduction transducers generate acoustic pressure waves by vibrating one or more portions of the auricular cartilage of the ears of the user. A cartilage conduction transducer may be coupled to a portion of a headset, and may be configured to be coupled to one or more portions of the auricular cartilage of the ear. For example, the cartilage conduction transducer may couple to the back of an auricle of the ear of the user. The cartilage conduction transducer may be located anywhere along the auricular cartilage around the outer ear (e.g., the pinna, the tragus, some other portion of the auricular cartilage, or some combination thereof). Vibrating the one or more portions of auricular cartilage may generate: airborne acoustic pressure waves outside the ear canal; tissue born acoustic pressure waves that cause some portions of the ear canal to vibrate thereby generating an airborne acoustic pressure wave within the ear canal; or some combination thereof. The generated airborne acoustic pressure waves propagate down the ear canal toward the ear drum.

The transducer array 210 generates audio content in accordance with instructions from the audio controller 230. In some embodiments, the audio content is spatialized. Spatialized audio content is audio content that appears to originate from a particular direction and/or target region (e.g., an object in the local area and/or a virtual object). For example, spatialized audio content can make it appear that sound is originating from a virtual singer across a room from a user of the audio system 200. The transducer array 210 may be coupled to a wearable device (e.g., the headset 100 or the headset 105). In alternate embodiments, the transducer array 210 may be a plurality of speakers that are separate from the wearable device (e.g., coupled to an external console).

The sensor array 220 detects sounds within a local area surrounding the sensor array 220. The sensor array 220 may include a plurality of acoustic sensors that each detect air pressure variations of a sound wave and convert the detected sounds into an electronic format (analog or digital). The plurality of acoustic sensors may be positioned on a headset (e.g., headset 100 and/or the headset 105), on a user (e.g., in an ear canal of the user), on a neckband, or some combination thereof. An acoustic sensor may be, e.g., a microphone, a vibration sensor, an accelerometer, or any combination thereof. In some embodiments, the sensor array 220 is configured to monitor the audio content generated by the transducer array 210 using at least some of the plurality of acoustic sensors. Increasing the number of sensors may improve the accuracy of information (e.g., directionality) describing a sound field produced by the transducer array 210 and/or sound from the local area.

The audio controller 230 controls operation of the audio system 200. In the embodiment of FIG. 2, the audio controller 230 includes a data store 235, a DOA estimation module 240, a transfer function module 250, a tracking module 260, a beamforming module 270, and a sound filter module 280. The audio controller 230 may be located inside a headset, in some embodiments. Some embodiments of the audio controller 230 have different components than those described here. Similarly, functions can be distributed among the components in different manners than described here. For example, some functions of the controller may be performed external to the headset. The user may opt in to allow the audio controller 230 to transmit data captured by the headset to systems external to the headset, and the user may select privacy settings controlling access to any such data.

The data store 235 stores data for use by the audio system 200. Data in the data store 235 may include sounds recorded in the local area of the audio system 200, audio content, head-related transfer functions (HRTFs), transfer functions for one or more sensors, array transfer functions (ATFs) for one or more of the acoustic sensors, sound source locations, virtual model of local area, direction of arrival estimates, sound filters, and other data relevant for use by the audio system 200, or any combination thereof.

The DOA estimation module 240 is configured to localize sound sources in the local area based in part on information from the sensor array 220. Localization is a process of determining where sound sources are located relative to the user of the audio system 200. The DOA estimation module 240 performs a DOA analysis to localize one or more sound sources within the local area. The DOA analysis may include analyzing the intensity, spectra, and/or arrival time of each sound at the sensor array 220 to determine the direction from which the sounds originated. In some cases, the DOA analysis may include any suitable algorithm for analyzing a surrounding acoustic environment in which the audio system 200 is located.

For example, the DOA analysis may be designed to receive input signals from the sensor array 220 and apply digital signal processing algorithms to the input signals to estimate a direction of arrival. These algorithms may include, for example, delay and sum algorithms where the input signal is sampled, and the resulting weighted and delayed versions of the sampled signal are averaged together to determine a DOA. A least mean squared (LMS) algorithm may also be implemented to create an adaptive filter. This adaptive filter may then be used to identify differences in signal intensity, for example, or differences in time of arrival. These differences may then be used to estimate the DOA. In another embodiment, the DOA may be determined by converting the input signals into the frequency domain and selecting specific bins within the time-frequency (TF) domain to process. Each selected TF bin may be processed to determine whether that bin includes a portion of the audio spectrum with a direct path audio signal. Those bins having a portion of the direct-path signal may then be analyzed to identify the angle at which the sensor array 220 received the direct-path audio signal. The determined angle may then be used to identify the DOA for the received input signal. Other algorithms not listed above may also be used alone or in combination with the above algorithms to determine DOA.

In some embodiments, the DOA estimation module 240 may also determine the DOA with respect to an absolute position of the audio system 200 within the local area. The position of the sensor array 220 may be received from an external system (e.g., some other component of a headset, an artificial reality console, a mapping server, a position sensor (e.g., the position sensor 190), etc.). The external system may create a virtual model of the local area, in which the local area and the position of the audio system 200 are mapped. The received position information may include a location and/or an orientation of some or all of the audio system 200 (e.g., of the sensor array 220). The DOA estimation module 240 may update the estimated DOA based on the received position information.

The transfer function module 250 is configured to generate one or more acoustic transfer functions. Generally, a transfer function is a mathematical function giving a corresponding output value for each possible input value. Based on parameters of the detected sounds, the transfer function module 250 generates one or more acoustic transfer functions associated with the audio system. The acoustic transfer functions may be array transfer functions (ATFs), head-related transfer functions (HRTFs), other types of acoustic transfer functions, or some combination thereof. An ATF characterizes how the microphone receives a sound from a point in space.

An ATF includes a number of transfer functions that characterize a relationship between the sound source and the corresponding sound received by the acoustic sensors in the sensor array 220. Accordingly, for a sound source there is a corresponding transfer function for each of the acoustic sensors in the sensor array 220. And collectively the set of transfer functions is referred to as an ATF. Accordingly, for each sound source there is a corresponding ATF. Note that the sound source may be, e.g., someone or something generating sound in the local area, the user, or one or more transducers of the transducer array 210. The ATF for a particular sound source location relative to the sensor array 220 may differ from user to user due to a person's anatomy (e.g., ear shape, shoulders, etc.) that affects the sound as it travels to the person's ears. Accordingly, the ATFs of the sensor array 220 are personalized for each user of the audio system 200.

In some embodiments, the transfer function module 250 determines one or more HRTFs for a user of the audio system 200. The HRTF characterizes how an ear receives a sound from a point in space. The HRTF for a particular source location relative to a person is unique to each ear of the person (and is unique to the person) due to the person's anatomy (e.g., ear shape, shoulders, etc.) that affects the sound as it travels to the person's ears. In some embodiments, the transfer function module 250 may determine HRTFs for the user using a calibration process. In some embodiments, the transfer function module 250 may provide information about the user to a remote system. The user may adjust privacy settings to allow or prevent the transfer function module 250 from providing the information about the user to any remote systems. The remote system determines a set of HRTFs that are customized to the user using, e.g., machine learning, and provides the customized set of HRTFs to the audio system 200.

The tracking module 260 is configured to track locations of one or more sound sources. The tracking module 260 may compare current DOA estimates and compare them with a stored history of previous DOA estimates. In some embodiments, the audio system 200 may recalculate DOA estimates on a periodic schedule, such as once per second, or once per millisecond. The tracking module may compare the current DOA estimates with previous DOA estimates, and in response to a change in a DOA estimate for a sound source, the tracking module 260 may determine that the sound source moved. In some embodiments, the tracking module 260 may detect a change in location based on visual information received from the headset or some other external source. The tracking module 260 may track the movement of one or more sound sources over time. The tracking module 260 may store values for a number of sound sources and a location of each sound source at each point in time. In response to a change in a value of the number or locations of the sound sources, the tracking module 260 may determine that a sound source moved. The tracking module 260 may calculate an estimate of the localization variance. The localization variance may be used as a confidence level for each determination of a change in movement.

The beamforming module 270 is configured to process one or more ATFs to selectively emphasize sounds from sound sources within a certain area while de-emphasizing sounds from other areas. In analyzing sounds detected by the sensor array 220, the beamforming module 270 may combine information from different acoustic sensors to emphasize sound associated from a particular region of the local area while deemphasizing sound that is from outside of the region. The beamforming module 270 may isolate an audio signal associated with sound from a particular sound source from other sound sources in the local area based on, e.g., different DOA estimates from the DOA estimation module 240 and the tracking module 260. The beamforming module 270 may thus selectively analyze discrete sound sources in the local area. In some embodiments, the beamforming module 270 may enhance a signal from a sound source. For example, the beamforming module 270 may apply sound filters which eliminate signals above, below, or between certain frequencies. Signal enhancement acts to enhance sounds associated with a given identified sound source relative to other sounds detected by the sensor array 220.

The sound filter module 280 determines sound filters for the transducer array 210. In some embodiments, the sound filters cause the audio content to be spatialized, such that the audio content appears to originate from a target region. The sound filter module 280 may use HRTFs and/or acoustic parameters to generate the sound filters. The acoustic parameters describe acoustic properties of the local area. The acoustic parameters may include, e.g., a reverberation time, a reverberation level, a room impulse response, etc. In some embodiments, the sound filter module 280 calculates one or more of the acoustic parameters. In some embodiments, the sound filter module 280 requests the acoustic parameters from a mapping server (e.g., as described below with regard to FIG. 9).

The sound filter module 280 provides the sound filters to the transducer array 210. In some embodiments, the sound filters may cause positive or negative amplification of sounds as a function of frequency.

As further described above in conjunction with FIG. 1A, a headset 100 includes one or more speakers 160. In various embodiments, multiple speakers 160 are included in an audio device that is included in the headset 100. FIG. 3 is a side view of an audio device 300 including a speaker 305 and an additional speaker 310 (coordinate system provided for reference). While FIG. 3 shows the audio device 300 including the speaker 305 and the additional speaker 310, in other embodiments, the audio device 300 includes a single speaker, such as the speaker 305 of the speaker 310. In the example of FIG. 3, the speaker 305 and the additional speaker 310 are opposite to each other and positioned to direct audio waves in opposite directions (e.g., in directions that are oriented 180 degrees relative to each other). The example orientation of the speaker 305 and the additional speaker 310 in FIG. 3 allows force generated by the additional speaker 310 outputting audio content offsetting and cancelling force generated by the speaker 305 when outputting audio content. Such a configuration allows the speaker 305 and the additional speaker 310 to cancel movement or vibration of the audio device 300 from audio signals output by the speaker 305 or by the additional speaker 310, and vice versa. This prevents vibration of the audio device 300 from introducing error into one or more measurement signals generated by the position sensor 190.

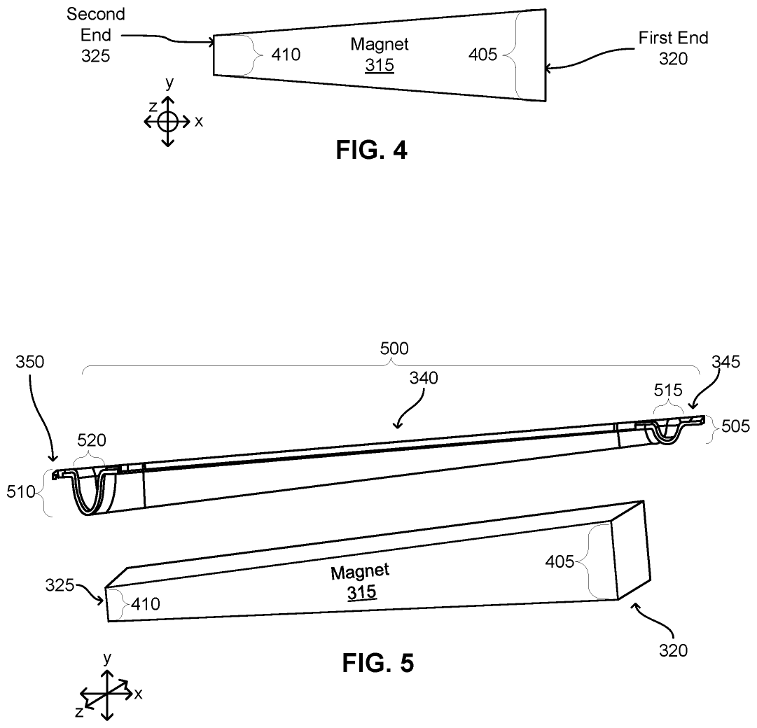

The speaker 305 and the additional speaker 310 share a magnet 315, which is a permanent magnet in various embodiments. The magnet 315 has a first end 320 and a second end 325, with the magnet 315 having a wedge shape from the first end 320 to the second end 325. FIG. 4 is a side view of one embodiment of the magnet 315 having a wedge-shape (coordinate system provided for reference). As shown in FIG. 4, the first end 325 of the magnet 315 has a first width 405, while the second end 325 of the magnet 315 has a second width 410. In the embodiment shown by FIG. 4, the first width 405 is greater than the second width 410, causing magnet 315 to taper in width from the first width 405 to the smaller second width 410 along a length of the magnet 315. As used herein, the “length” of the magnet 315 is along an axis that is perpendicular to a plane including the first end 320, while the “width” of the magnet 315 is determined along an additional axis that is perpendicular to the axis used to specify the length (i.e., along a plane parallel to the first end 320 of the magnet 315). In some embodiments, the first width 405 and the second width 410 have specific values relative to each other. For example, a ratio of the first width 405 to the second width 410 has a specific value or is in a specific range of values in various embodiments. In various embodiments, the first width 405 and the second weight 410 are determined from a location in which the speaker 305 or the additional speaker 315 is included. For example, when the speaker 305 is included in a frame 110 of a headset 100, the first width 405 is based on a width of a portion of the frame 110 including the first end 320 of the magnet, while the second width 410 is based on a width of another portion of the frame 110 including the second end 325 of the magnet 315. This allows the first width 405 or the second width 410 to differ based on different configurations for the speaker 305 or for the additional speaker 310.

Referring back to FIG. 3, the speaker 305 also includes a diaphragm 330 and one or more voice coils 335. The diaphragm 330 is a transducer configured to convert mechanical vibration into sound. In various embodiments, the diaphragm 330 is a membrane to which the one or more voice coils 335 are attached. The diaphragm 330 is a thin, semi-rigid material in various embodiments.

The voice coil 335 is a coil of wire configured to receive current. As the current passes through the coil of wire, a magnetic field is produced. The magnetic field produced by passage of current through the voice coil 335 reacts with a magnetic field from the magnet 315, with the diaphragm 330 moving in response to the reaction between the magnetic field produced by the voice coil 335 and the magnetic field of the magnet 315. For example, the diaphragm 330 moves away from the magnet 315 when the magnetic field from the magnet 315 repels a magnetic field generated by the voice coil 335, while the diaphragm 330 moves towards the magnet 315 when the magnetic field from the magnet 315 attracts the magnetic field generated by the voice coil 335.

Referring to FIG. 4, the magnet 315 is wedge shaped, so the magnetic field from the magnet 315 has different strengths at different locations along the length of the magnet 315. The width of the magnet 315 at a location affects the strength of the magnetic field from the magnet 315 at the location. Locations nearer to the first end 320 of the magnet 315 have a stronger magnetic field than locations nearer to the second end 325 of the magnet 315. Hence, the strength of the magnetic field of the magnet 315 at a location along the length of the magnet 315 is directly related to a width of the magnet 315 at the location. Locations along the length of the magnet 315 where the magnet 315 has a larger width have a stronger magnetic field, while locations along the length of the magnet 315 where the magnet 315 has a smaller width have a weaker magnetic field.

Referring back to FIG. 3, to compensate for effects from varying strength of the magnetic field of the magnet 315 along the length of the magnet 315 on movement of the diaphragm 330, a stiffness of a surround 340 coupled to an edge of the diaphragm 330 varies along a length of the surround 340. As used herein, the “length” of the surround 340 is along an axis that is perpendicular to a plane including the first end 320 of the magnet 315. The surround 340 couples the diaphragm 330 to a frame, such as the frame 110 of a headset 100. The surround 340 allows the diaphragm 330 to move in response to reactions between the magnetic field of the voice coil 335 and the magnetic field of the magnet 315, while providing stability to movement of the diaphragm 330. Additionally, the surround 340 returns the diaphragm 330 to a resting position when the voice coil 335 is not generating a magnetic field. In some embodiments, the surround 340 is liquid silicone rubber, but in other embodiments other materials are used to form the surround 340.

Varying the stiffness of the surround 340 along the length of the surround 340 allows different portions of the surround 340 to provide differing levels of resistance to movement of the diaphragm 330. Locations on the surround 340 nearer to wider portions of the magnet 315 have higher stiffnesses, while locations on the surround 340 nearer to narrower portions of the magnet 315 have lower stiffnesses. For example, a first end 345 of the surround 340 is proximate to the first end 320 of the magnet 315. As the first end 320 of the magnet 315 has a maximum width, the first end 345 of the surround 340 has a highest stiffness. Similarly, a second end 350 of the surround 340 is proximate to the second end 325 of the magnet 315, which has a minimum width, so the second end 350 of the surround 340 has a minimum stiffness. An increased stiffness of the surround 340 in locations of the surround 340 nearer to wider portions of the magnet 315 provides more resistance to movement of the diaphragm 330, which offsets increased movement of the diaphragm 340 from the increased strength of magnetic field in wider locations of the magnet 315. Similarly, a decreased stiffness of the surround 340 in locations of the surround 340 nearer to narrower portions of the magnet 315 provides less resistance to movement of the diaphragm 330 by the surround 340, offsetting a decreased strength of the magnetic field in thinner locations of the magnet 315 causing less movement of the diaphragm 330. Varying the stiffness of the surround 340 along the length of the surround 340 allows the surround 340 to compensate for variations in an amount of movement of the diaphragm 330 at different locations along the length of the magnet 315 caused by varying strengths of the magnetic field along the length of the magnet 315.

In various embodiments, different configurations are used to vary the stiffness of the surround 340 along the length of the surround 340. For example, a cross-section of the surround 340 changes across the length of the surround 340, with different cross-sections providing different stiffnesses. FIG. 5 shows an example perspective view of a surround 340 with a varying cross-section. For reference, FIG. 5 also shows the magnet 315 to identify locations of the surround 340 relative to locations of the magnet 315 (coordinate system provided for reference).

In the example of FIG. 5, the surround 340 has a length 500 that is determined as perpendicular to a plane including the first end 320 of the magnet 325. The surround in FIG. 5 has a cross-section that is an arch having endpoints in a common plane, with the endpoints separated by a width. The arch has a height determined as a distance between the plane including the endpoints and an apex of the arch. In various embodiments, such as the embodiment shown in FIG. 5, the height of the arch varies along a length 500 of the surround, with different heights of the arch providing different stiffnesses of the surround 340. For example, at a first end 345 of the surround 350 that is nearest to the first end 320 of the magnet 315, the cross-sectional arch of the surround 350 has height 505. Similarly, at a second end 350 of the surround 350 that is nearest to the second end 325 of the magnet 315, the cross-sectional arch of the surround 350 has height 510. Height 505 is less than height 510, so a stiffness of the surround 340 at the first end 345 is larger than a stiffness of the surround 340 at the second end 350. This allows the first end 345 of the surround 340 to provide increased resistance to movement of the diaphragm 330, which mitigates a stronger magnetic field at the first end 320 of the magnet 315 from the first width 405 of the magnet 315. Conversely, height 510 decreases a stiffness of the surround 340 at the second end 350, allowing the diaphragm 330 to more freely move based on the weaker magnetic field from the relatively smaller second width 410 of the magnet 415 at the second end 325. In various embodiments, the height of the arch comprising the surround 340 continuously changes along the length 500 of the surround 340. For example, the height of the arch comprising the surround 340 continuously increases from height 505 at the first end 345 of the surround 340 to height 510 at the second end 350 of the surround 340. In various embodiments, a rate of change of the height of the arch comprising the surround 340 is directly related to a rate of change in width of the magnet 315 from the first end 320 of the magnet 315 to the second end 325 of the magnet 315, allowing the stiffness of the surround 340 to change consistent with the strength of the magnetic field from the magnet 315 along the length 500 of the surround 340. In other embodiments, the height of the arch comprising the surround 340 changes along the length 500 of the surround 340 between the first end 345 and the second end 350 at a different rate than the rate of change in width of the magnet 315 from the first end 320 to the second end 325. In the above description, increased height of the surround 340 corresponds to decreased stiffness. However, in other embodiments, increased height of the surround 340 may correspond to increased stiffness. The relationship of height and stiffness depends on properties of the surround 340, such as the material properties, thickness, and/or arch shape of the surround 340.

While the embodiment shown in FIG. 5 varies the height of the arch of the surround 340 across the length 500 of the surround 340 to vary a stiffness of the surround 340 along the length 500 of the surround 340, in other embodiments, different characteristics of the surround 340 are varied along the length 500 to vary the stiffness of the surround 340. For example, the surround has an arch cross-section (e.g., the same as in FIG. 5), and a width of the arch varies long the length 500 of the surround. As used herein, the “width” of the arch is a distance between the endpoints of the arch in the plane that includes the endpoints. In some embodiments, the width of the arch comprising the surround 340 varies from a first width 515, which provides a maximum stiffness for the surround 340, at the first end 345 of the surround 340 to a second width 520, which provides a minimum stiffness for the surround 340, at the second end 350 of the surround 340. In various embodiments, the first width 515 of the surround is smaller than the second width 520 of the surround, so the stiffness of the first end 345 of the surround 340 is greater than the stiffness of the second end 350 of the surround 340. The width of the arch comprising the surround 340 continuously varies from the first width 515 to the second width 515 along the length 500 of the surround 340 in some embodiments. The height of the surround 340 remains constant along the length 500 of the surround 340 in some embodiments where the width of the surround 340 changes along the length 500 of the surround 340. Alternatively, the width of the surround 340 remains constant along the length of the surround 340 in some embodiments where the height of the surround 340 changes along the length 500 of the surround 340. In other embodiments, both the width and the height of the surround 340 changes along the length 500 of the surround 340. In other embodiments, a composition of a material comprising the surround 340 varies along the length 500 of the surround 340, with differing compositions of the material comprising the surround 340 at different locations along the length of the surround 340 resulting in a stiffness of the surround 340 decreasing from a maximum stiffness at the first end 345 to a minimum stiffness at the second end 350. In some embodiments, the stiffness of the surround 340 at a location along the length 500 of the surround 340 is directly related to a width of the magnet 315 at the location along the length 500 of the surround 340, so the surround 340 has higher stiffnesses at locations along its length 500 where the magnet 315 has larger widths.

In various embodiments, the stiffness of the surround 340 at locations along the length 500 of the surround 340 is configured based on a displacement of the diaphragm 330 at different locations along the length 500 of the surround. As further described above in conjunction with FIG. 3, when a voice coil 335 coupled to the diaphragm 330 generates a magnetic field, the diaphragm 330 moves in response to the generated magnetic field and a magnetic field of the magnet 315. This causes the diaphragm 330 to be displaced relative to the magnet 315, either towards the magnet 315 or away from the magnet 315. As the strength of the magnetic field of the magnet 315 varies based on a width of the magnet 315, portions of the diaphragm 330 in different locations along the length 500 of the surround 340 move different amounts based on the differing magnetic field strength of the magnet 315. In some embodiments, stiffnesses of the surround 340 at different locations along the length 500 of the surround 340 are configured based on movement of the diaphragm 330.

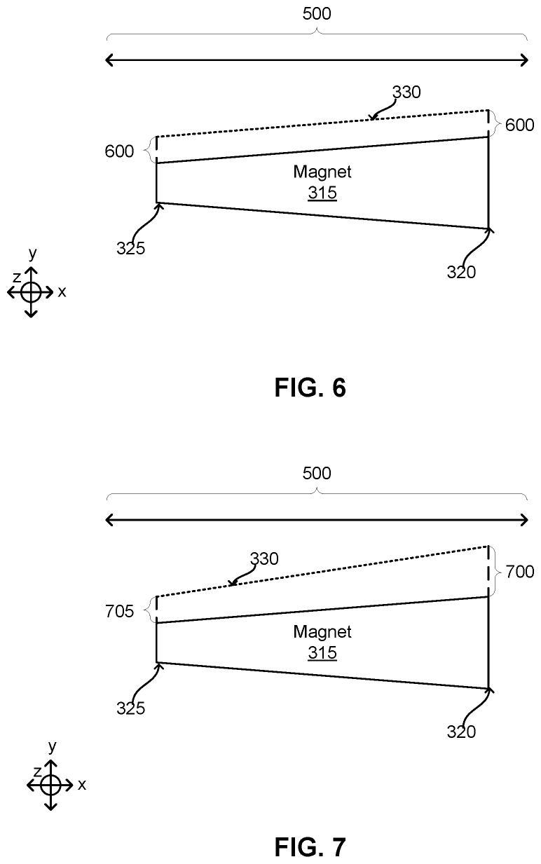

FIG. 6 shows an example of movement of the diaphragm 300 relative to the magnet 315 at different locations along a length 500 of the surround 340 (coordinate system provided for reference). In the example of FIG. 6, stiffnesses of the surround 340 at different locations along the length 500 of the surround 340 are configured so there is a uniform displacement 600 of portions of the diaphragm 330 relative to the magnet 315 at different locations along the length 500 of the surround 340 when the voice coil 335 generates a magnetic field. To provide the uniform displacement 600 relative to the magnet 315, stiffnesses of the surround 340 at locations proximate to wider portions of the magnet 315 are higher, attenuating displacement of the diaphragm 300 by compensating for increased strength of the magnetic field from the magnet 315. Similarly, stiffnesses of the surround 340 at locations proximate to narrower portions of the magnet 315 are lower, providing less resistance to displacement of the diaphragm 330 to offset decreased strength of the magnetic field from the magnet 315. Hence, the varying stiffness of the surround 340 along its length 500 allows balanced movement of the diaphragm 330 relative to the magnet 315 along the length 500 of the surround 340 by compensating for the varying strength of the magnetic field of the magnet 315 at different locations. The varying stiffness of the surround 340 allows the displacement of the diaphragm 330 to pivot along the length of the magnet 315 from the varying magnetic field strength of the wedge-shaped magnet 315, increasing a volume displaced by movement of the diaphragm 330, providing an increased force factor for the speaker 305, allowing the diaphragm 330 to more precisely response to signals applied to the voice coil 325. Additionally, varying the stiffness of the surround 340 along its length 500, in combination with the wedge-shaped magnet 315, reduces power consumption of the speaker 305 relative to speakers including a magnet with a uniform width.

In some embodiments, the stiffness of the surround 340 varies along its length 500 so portions of the diaphragm 330 at different locations along the length 500 of the surround 340 have different amounts of displacement relative to the magnet 315. FIG. 7 shows an alternative example movement of the diaphragm 300 relative to the magnet 315 at different locations along a length 500 of the surround 340 (coordinate system provided for reference). For example, stiffnesses of the surround 340 proximate to wider portions of the magnet 315 allow portions of the diaphragm 330 nearer to wider portions of the magnet 315 to have greater displacement relative to the magnet 315 than portions of the diaphragm 330 nearer to thinner portions of the magnet 315. In the example of FIG. 7, the surround 340 has a stiffness at the first end 345, which is nearest to the first end 320 of the magnet 315, allowing the diaphragm 300 to have a first displacement 700 relative to the magnet 315 at the first end 345. The surround 340 has another stiffness at the second end 350, which is nearest to the second end 325 of the magnet 315, where the diaphragm 300 has a second displacement 705 relative to the magnet 315 at the second end 350. As shown in FIG. 7, the first displacement 700 is greater than the second displacement 705, allowing portions of the diaphragm 300 nearer to the first end 320 of the magnet to have a a greater range of displacement relative to the magnet 315 than other portions of the diaphragm nearer to the second end 325 of the magnet 315. This allows portions of the diaphragm 300 nearer to wider portions of the magnet 315 to have a greater range of motion relative to the magnet 315 than portions of the diaphragm 300 nearer to narrower portions of the magnet 315. Allowing for non-uniform displacement of the diaphragm 330 relative to the magnet 315 along the length 500 of the surround 340 further increases a volume of air displaced by movement of the diaphragm 330 by allowing portions of the diaphragm 330 nearer to wider portions of the magnet 315 to have a greater range of motion, which more efficiently uses a volume available to the diaphragm 300 at different locations relative to the magnet 315.

Referring back to FIG. 3, the device 300 includes an additional speaker 310. The additional speaker 310 includes an additional diaphragm 355 positioned proximate to the magnet 315, with one or more additional voice coils 360 coupled to the additional diaphragm 355. As further described above regarding the diaphragm 330, current passing through an additional voice coil 360 produces a magnetic field, and reactions between the magnetic field of the additional voice coil 360 and the magnetic field of the magnet 315 cause the additional diaphragm 335 to move relative to the magnet 315. The diaphragm 330 and the additional diaphragm 355 are on opposite sides of the magnet 315 in various embodiments. In various embodiments, the diaphragm 330 and the additional diaphragm 355 face directions that are 180 degrees relative to each other, which allows generation of audio waves by diaphragm 330 to cancel force from generation of audio waves by the additional diaphragm 355, and vice versa, which decreases vibration of the device 300 when audio content is output.

An additional surround 365 is coupled to an edge of the additional diaphragm 350. Like the surround 340, further described above, the additional surround 365 compensates for effects from varying strength of the magnetic field of the magnet 315 along the length of the magnet 315 on movement of the additional diaphragm 355. As further described above regarding the surround 340, a stiffness of the additional surround 365 varies along a length of the additional surround 365. The “length” of the additional surround 365 is along an axis that is perpendicular to a plane including the first end 320 of the magnet 315. As further described above in conjunction with FIGS. 5-7, the varying stiffness of the additional surround 365 along the length of the additional surround 365 provides different resistance to movement of the additional diaphragm 355 at different locations along the length of the additional surround 365. As further described above in conjunction with FIGS. 5-7, the varying stiffness of the additional surround 365 offsets variations in a strength of the magnetic field of the magnet 315 at different locations along the length of the additional surround 365 caused by the different widths of the magnet 315 at different locations along the length of the additional surround 365.

For example, the additional surround 365 has an additional first end 370 that is nearest the first end 320 of the magnet 315. Similarly, the additional surround 365 has an additional second end 375 that is nearest the second end 325 of the magnet 315. As further described above in conjunction with FIGS. 4 and 5, the first end 320 of the magnet 315 is a widest point of the magnet 315, with a strength of the magnetic field of the magnet 315 having a maximum at the first end 320 of the magnet 315. To reduce movement of the additional diaphragm 355 from the magnetic field at the first end 320 of the magnet 315, the additional surround 365 has a maximum stiffness at the additional first end 370. Similarly, the second end 325 of the magnet 315 is a narrowest point of the magnet 315, with a strength of the magnetic field of the magnet 315 having a minimum at the second end 325 of the magnet 315. To allow greater movement of the additional diaphragm 355 in view of the lower magnetic field at the second end 325 of the magnet 315, the additional surround 365 has a minimum stiffness at the additional second end 375. As further described above in conjunction with FIGS. 5-7, the stiffness of the additional surround 365 varies along the length of the additional surround 365 so the additional surround 365 has lower stiffnesses in locations corresponding to locations of the magnet 315 having a weaker magnetic field, while locations along the length of the additional surround 365 proximate to locations of the magnet 315 having a stronger magnetic field have higher stiffnesses.

In various embodiments, the voice coil 335 and the additional voice coil 360 receive a common signal. This causes the voice coil 335 and the additional voice coil 360 to generate equivalent magnetic fields in response to the common signal. As the diaphragm 330 and the additional diaphragm 355 are positioned opposite to each other on different sides of the magnet 315, the diaphragm 330 and the additional diaphragm 355 are displaced and equal amount, but in opposite directions, relative to the magnet 315 in response to the common signal. This allows force from movement of the diaphragm 330 to be offset by force from movement of the additional diaphragm 355 in the opposite direction. While FIG. 3 shows an embodiment where the device 300 includes the speaker 305 and the additional speaker 310, in other embodiments, the device 300 includes the speaker 305 and not the additional speaker 310 or includes the additional speaker 310 and not the speaker 305.

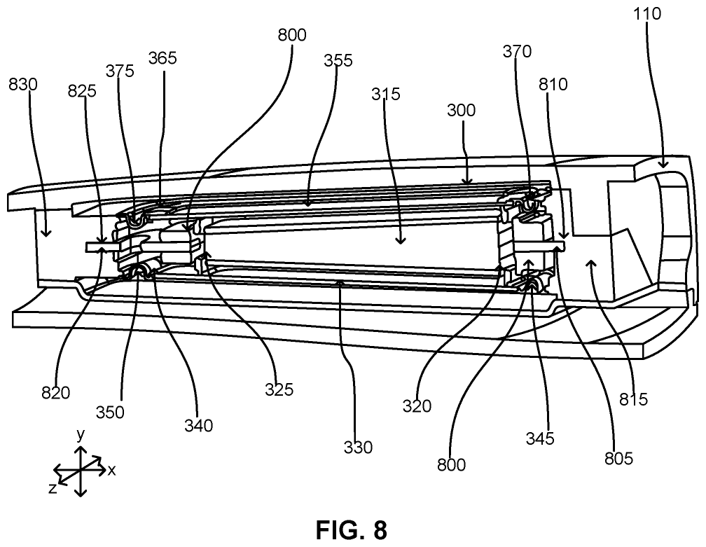

FIG. 8 is a cross-section of a portion of a frame 110 of a headset 100 including an audio device 300 including a wedge-shaped magnet 315 (coordinate system provided for reference). For example, the portion of the frame 110 shown in FIG. 8 is an end piece of the frame 110 in FIG. 1A, such as a temple of the frame 110 in FIG. 1A having an eyeglass form factor. In other embodiments, the audio device 300 is included in a different portion of the frame 110 or is included in a different component.

As shown in FIG. 8, the audio device 300 includes a magnet 315 having a wedge-shape that tapers from a first width 320 to a second width 325. As further described above in conjunction with FIGS. 3 and 4, the second width 325 is smaller than the first width 320. A rate at which the width of the magnet 315 changes from the first width 320 to the second width 325 is based on a shape or structure of the portion of the frame 110 in which the audio device 300 is included in some embodiments. Such embodiments allow the change in width of the magnet 315 to vary for different dimensions of different frames 110 or for different dimensions of a component in which the audio device 300 is included.

In the example shown by FIG. 8, the audio device 300 includes a surround 340 proximate to a first side of the magnet 315 and a second surround 365 proximate to a second side of the magnet 315 that is opposite to the first side of the magnet 315. As further described above in conjunction with FIGS. 3 and 5, the surround 340 has a first end 345 nearest the first end 320 of the magnet 315 and has a second end 350 nearest the second end 325 of the magnet 315. A stiffness of the surround 340 varies along a length of the surround 340 from the first end 345 to the second end 350, as further described above in conjunction with FIGS. 3 and 5-7. The stiffness of the surround 340 is higher at the first end 345 than at the second end 350, so the first end 345 of the surround 340 provides greater resistance to movement for a diaphragm 330 coupled to the surround 340 than the second end 350 of the surround 340. In various embodiments, a stiffness of a portion of the surround 340 is directly related to a strength of a magnetic field from the magnet 315 proximate to the portion of the surround 340. This results in the surround 340 having higher stiffnesses in portions that are proximate to a stronger magnetic field from the magnet 315.

Similarly, the additional surround 365 has an additional first end 370 nearest the first end 320 of the magnet 315 and has an additional second end 375 nearest the second end 325 of the magnet 315. An additional stiffness of the additional surround 365 varies along a length of the additional surround 365 from the additional first end 370 to the additional second end 375, as further described above in conjunction with FIGS. 3 and 5-7. The stiffness of the additional surround 365 is higher at the additional first end 370 than at the additional second end 375, so the additional first end 370 of the additional surround 365 provides greater resistance to movement for an additional diaphragm 355 coupled to the additional surround 365 than the additional second end 375 of the additional surround 365. In various embodiments, a stiffness of a portion of the additional surround 365 is directly related to a strength of a magnetic field from the magnet 315 proximate to the portion of the additional surround 365. This results in the additional surround 365 having higher stiffnesses in portions that are proximate to a stronger magnetic field from the magnet 315.

To include the audio device 300 in the frame 110, the audio device 300 is included in an assembly 800. In various embodiments, the assembly 800 includes the magnet 315. In other embodiments, the assembly 800 includes the magnet 315, the diaphragm 330 (with the one or more voice coils 335 coupled to the diaphragm), the surround 340, the additional diaphragm 355 (with the one or more additional voice coils 360 coupled to the additional diaphragm 355), and the additional surround 365. Including the audio device 300 in the assembly 800 simplifies movement or positioning of the audio device 300 in the portion of the frame 110. In various embodiments, the assembly 800 encloses or partially encloses the audio device 300. The assembly 800 includes a first tongue 805 on a side of the assembly 800 nearest the first side 320 of the magnet 315. The first tongue 805 is configured to be inserted into a slot 810 in a first portion 815 of the frame 110. In various embodiments, the slot 810 is a groove cut or etched into the portion of the frame 110, with the slot 810 having a length and a width that is within a threshold amount of a length and a width of the first tongue 805.

Similarly, the assembly 800 includes a second tongue 820 on an additional side of the assembly 800 nearest the second side 325 of the magnet 315. The second tongue 820 is configured to be inserted into an additional slot 825 that is in a second portion 830 of the frame 110. In various embodiments, the additional slot 825 is a groove cut or etched into the second portion 830 of the frame 110, with the additional slot 825 having a length and a width that is within a threshold amount of a length and a width of the second tongue 820. Having the first tongue 805 inserted into the slot 810 of the portion 815 of the frame 110 and the second tongue 820 inserted into the additional slot 825 of the additional portion 830 of the frame 100 allows the audio device 300 to be securely coupled to the frame 110, while simplifying insertion of the audio device 300 into the frame 110. In the example of FIG. 8, the tongues 805 and 820 are part of the same plate that holds the magnet 315. The plate forms a ring around the magnet 315 that holds the Magnet 315 in place. In the cross-section of FIG. 8, the middle portion of the plate is not visible because it is behind the magnet 315.

FIG. 9 is a system 900 that includes a headset 905, in accordance with one or more embodiments. In some embodiments, the headset 905 may be the headset 100 of FIG. 1A or the headset 105 of FIG. 1B. The system 900 may operate in an artificial reality environment (e.g., a virtual reality environment, an augmented reality environment, a mixed reality environment, or some combination thereof). The system 900 shown by FIG. 9 includes the headset 905, an input/output (I/O) interface 910 that is coupled to a console 915, the network 920, and the mapping server 925. While FIG. 9 shows an example system 900 including one headset 905 and one I/O interface 910, in other embodiments any number of these components may be included in the system 900. For example, there may be multiple headsets each having an associated I/O interface 910, with each headset and I/O interface 910 communicating with the console 915. In alternative configurations, different and/or additional components may be included in the system 900. Additionally, functionality described in conjunction with one or more of the components shown in FIG. 9 may be distributed among the components in a different manner than described in conjunction with FIG. 9 in some embodiments. For example, some or all of the functionality of the console 915 may be provided by the headset 905.

The headset 905 includes the display assembly 930, an optics block 935, one or more position sensors 940, and the DCA 945. Some embodiments of headset 905 have different components than those described in conjunction with FIG. 9. Additionally, the functionality provided by various components described in conjunction with FIG. 9 may be differently distributed among the components of the headset 905 in other embodiments, or be captured in separate assemblies remote from the headset 905.

The display assembly 930 displays content to the user in accordance with data received from the console 915. The display assembly 930 displays the content using one or more display elements (e.g., the display elements 120). A display element may be, e.g., an electronic display. In various embodiments, the display assembly 930 comprises a single display element or multiple display elements (e.g., a display for each eye of a user). Examples of an electronic display include: a liquid crystal display (LCD), an organic light emitting diode (OLED) display, an active-matrix organic light-emitting diode display (AMOLED), a waveguide display, some other display, or some combination thereof. Note in some embodiments, the display element 120 may also include some or all of the functionality of the optics block 935.

The optics block 935 may magnify image light received from the electronic display, corrects optical errors associated with the image light, and presents the corrected image light to one or both eyeboxes of the headset 905. In various embodiments, the optics block 935 includes one or more optical elements. Example optical elements included in the optics block 935 include: an aperture, a Fresnel lens, a convex lens, a concave lens, a filter, a reflecting surface, or any other suitable optical element that affects image light. Moreover, the optics block 935 may include combinations of different optical elements. In some embodiments, one or more of the optical elements in the optics block 935 may have one or more coatings, such as partially reflective or anti-reflective coatings.

Magnification and focusing of the image light by the optics block 935 allows the electronic display to be physically smaller, weigh less, and consume less power than larger displays. Additionally, magnification may increase the field of view of the content presented by the electronic display. For example, the field of view of the displayed content is such that the displayed content is presented using almost all (e.g., approximately 110 degrees diagonal), and in some cases, all of the user's field of view. Additionally, in some embodiments, the amount of magnification may be adjusted by adding or removing optical elements.

In some embodiments, the optics block 935 may be designed to correct one or more types of optical error. Examples of optical error include barrel or pincushion distortion, longitudinal chromatic aberrations, or transverse chromatic aberrations. Other types of optical errors may further include spherical aberrations, chromatic aberrations, or errors due to the lens field curvature, astigmatisms, or any other type of optical error. In some embodiments, content provided to the electronic display for display is pre-distorted, and the optics block 935 corrects the distortion when it receives image light from the electronic display generated based on the content.

The position sensor 940 is an electronic device that generates data indicating a position of the headset 905. The position sensor 940 generates one or more measurement signals in response to motion of the headset 905. The position sensor 190 is an embodiment of the position sensor 940. Examples of a position sensor 940 include: one or more IMUS, one or more accelerometers, one or more gyroscopes, one or more magnetometers, another suitable type of sensor that detects motion, or some combination thereof. The position sensor 940 may include multiple accelerometers to measure translational motion (forward/back, up/down, left/right) and multiple gyroscopes to measure rotational motion (e.g., pitch, yaw, roll). In some embodiments, an IMU rapidly samples the measurement signals and calculates the estimated position of the headset 905 from the sampled data. For example, the IMU integrates the measurement signals received from the accelerometers over time to estimate a velocity vector and integrates the velocity vector over time to determine an estimated position of a reference point on the headset 905. The reference point is a point that may be used to describe the position of the headset 905. While the reference point may generally be defined as a point in space, however, in practice the reference point is defined as a point within the headset 905.

The DCA 945 generates depth information for a portion of the local area. The DCA includes one or more imaging devices and a DCA controller. The DCA 945 may also include an illuminator. Operation and structure of the DCA 945 is described above with regard to FIG. 1A.

The audio system 950 provides audio content to a user of the headset 905. The audio system 950 is substantially the same as the audio system 200 describe above. In some embodiments, the audio system 950 includes an audio device (e.g., 300) with a wedge-shaped magnet (e.g., 315). The audio system 950 may comprise one or more acoustic sensors, one or more transducers, and an audio controller. The audio system 950 may provide spatialized audio content to the user. In some embodiments, the audio system 950 may request acoustic parameters from the mapping server 925 over the network 920. The acoustic parameters describe one or more acoustic properties (e.g., room impulse response, a reverberation time, a reverberation level, etc.) of the local area. The audio system 950 may provide information describing at least a portion of the local area from e.g., the DCA 945 and/or location information for the headset 905 from the position sensor 940. The audio system 950 may generate one or more sound filters using one or more of the acoustic parameters received from the mapping server 925, and use the sound filters to provide audio content to the user.

The I/O interface 910 is a device that allows a user to send action requests and receive responses from the console 915. An action request is a request to perform a particular action. For example, an action request may be an instruction to start or end capture of image or video data, or an instruction to perform a particular action within an application. The I/O interface 910 may include one or more input devices. Example input devices include: a keyboard, a mouse, a game controller, or any other suitable device for receiving action requests and communicating the action requests to the console 915. An action request received by the I/O interface 910 is communicated to the console 915, which performs an action corresponding to the action request. In some embodiments, the I/O interface 910 includes an IMU that captures calibration data indicating an estimated position of the I/O interface 910 relative to an initial position of the I/O interface 910. In some embodiments, the I/O interface 910 may provide haptic feedback to the user in accordance with instructions received from the console 915. For example, haptic feedback is provided when an action request is received, or the console 915 communicates instructions to the I/O interface 910 causing the I/O interface 910 to generate haptic feedback when the console 915 performs an action.

The console 915 provides content to the headset 905 for processing in accordance with information received from one or more of: the DCA 945, the headset 905, and the I/O interface 910. In the example shown in FIG. 9, the console 915 includes an application store 955, a tracking module 960, and an engine 965. Some embodiments of the console 915 have different modules or components than those described in conjunction with FIG. 9. Similarly, the functions further described below may be distributed among components of the console 915 in a different manner than described in conjunction with FIG. 9. In some embodiments, the functionality discussed herein with respect to the console 915 may be implemented in the headset 905, or a remote system.

The application store 955 stores one or more applications for execution by the console 915. An application is a group of instructions, that when executed by a processor, generates content for presentation to the user. Content generated by an application may be in response to inputs received from the user via movement of the headset 905 or the I/O interface 910. Examples of applications include: gaming applications, conferencing applications, video playback applications, or other suitable applications.

The tracking module 960 tracks movements of the headset 905 or of the I/O interface 910 using information from the DCA 945, the one or more position sensors 940, or some combination thereof. For example, the tracking module 960 determines a position of a reference point of the headset 905 in a mapping of a local area based on information from the headset 905. The tracking module 960 may also determine positions of an object or virtual object. Additionally, in some embodiments, the tracking module 960 may use portions of data indicating a position of the headset 905 from the position sensor 940 as well as representations of the local area from the DCA 945 to predict a future location of the headset 905. The tracking module 960 provides the estimated or predicted future position of the headset 905 or the I/O interface 910 to the engine 965.

The engine 965 executes applications and receives position information, acceleration information, velocity information, predicted future positions, or some combination thereof, of the headset 905 from the tracking module 960. Based on the received information, the engine 965 determines content to provide to the headset 905 for presentation to the user. For example, if the received information indicates that the user has looked to the left, the engine 965 generates content for the headset 905 that mirrors the user's movement in a virtual local area or in a local area augmenting the local area with additional content. Additionally, the engine 965 performs an action within an application executing on the console 915 in response to an action request received from the I/O interface 910 and provides feedback to the user that the action was performed. The provided feedback may be visual or audible feedback via the headset 905 or haptic feedback via the I/O interface 910.

The network 920 couples the headset 905 and/or the console 915 to the mapping server 925. The network 920 may include any combination of local area and/or wide area networks using both wireless and/or wired communication systems. For example, the network 920 may include the Internet, as well as mobile telephone networks. In one embodiment, the network 920 uses standard communications technologies and/or protocols. Hence, the network 920 may include links using technologies such as Ethernet, 802.11, worldwide interoperability for microwave access (WiMAX), 2G/3G/4G mobile communications protocols, digital subscriber line (DSL), asynchronous transfer mode (ATM), InfiniBand, PCI Express Advanced Switching, etc. Similarly, the networking protocols used on the network 920 can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), etc. The data exchanged over the network 920 can be represented using technologies and/or formats including image data in binary form (e.g., Portable Network Graphics (PNG)), hypertext markup language (HTML), extensible markup language (XML), etc. In addition, all or some of links can be encrypted using conventional encryption technologies such as secure sockets layer (SSL), transport layer security (TLS), virtual private networks (VPNs), Internet Protocol security (IPsec), etc.

The mapping server 925 may include a database that stores a virtual model describing a plurality of spaces, wherein one location in the virtual model corresponds to a current configuration of a local area of the headset 905. The mapping server 925 receives, from the headset 905 via the network 920, information describing at least a portion of the local area and/or location information for the local area. The user may adjust privacy settings to allow or prevent the headset 905 from transmitting information to the mapping server 925. The mapping server 925 determines, based on the received information and/or location information, a location in the virtual model that is associated with the local area of the headset 905. The mapping server 925 determines (e.g., retrieves) one or more acoustic parameters associated with the local area, based in part on the determined location in the virtual model and any acoustic parameters associated with the determined location. The mapping server 925 may transmit the location of the local area and any values of acoustic parameters associated with the local area to the headset 905.

One or more components of system 900 may contain a privacy module that stores one or more privacy settings for user data elements. The user data elements describe the user or the headset 905. For example, the user data elements may describe a physical characteristic of the user, an action performed by the user, a location of the user of the headset 905, a location of the headset 905, an HRTF for the user, etc. Privacy settings (or “access settings”) for a user data element may be stored in any suitable manner, such as, for example, in association with the user data element, in an index on an authorization server, in another suitable manner, or any suitable combination thereof.

A privacy setting for a user data element specifies how the user data element (or particular information associated with the user data element) can be accessed, stored, or otherwise used (e.g., viewed, shared, modified, copied, executed, surfaced, or identified). In some embodiments, the privacy settings for a user data element may specify a “blocked list” of entities that may not access certain information associated with the user data element. The privacy settings associated with the user data element may specify any suitable granularity of permitted access or denial of access. For example, some entities may have permission to see that a specific user data element exists, some entities may have permission to view the content of the specific user data element, and some entities may have permission to modify the specific user data element. The privacy settings may allow the user to allow other entities to access or store user data elements for a finite period of time.

The privacy settings may allow a user to specify one or more geographic locations from which user data elements can be accessed. Access or denial of access to the user data elements may depend on the geographic location of an entity who is attempting to access the user data elements. For example, the user may allow access to a user data element and specify that the user data element is accessible to an entity only while the user is in a particular location. If the user leaves the particular location, the user data element may no longer be accessible to the entity. As another example, the user may specify that a user data element is accessible only to entities within a threshold distance from the user, such as another user of a headset within the same local area as the user. If the user subsequently changes location, the entity with access to the user data element may lose access, while a new group of entities may gain access as they come within the threshold distance of the user.

The system 900 may include one or more authorization/privacy servers for enforcing privacy settings. A request from an entity for a particular user data element may identify the entity associated with the request and the user data element may be sent only to the entity if the authorization server determines that the entity is authorized to access the user data element based on the privacy settings associated with the user data element. If the requesting entity is not authorized to access the user data element, the authorization server may prevent the requested user data element from being retrieved or may prevent the requested user data element from being sent to the entity. Although this disclosure describes enforcing privacy settings in a particular manner, this disclosure contemplates enforcing privacy settings in any suitable manner.

### Additional Configuration Information

The foregoing description of the embodiments has been presented for illustration; it is not intended to be exhaustive or to limit the patent rights to the precise forms disclosed. Persons skilled in the relevant art can appreciate that many modifications and variations are possible considering the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. An apparatus comprising:
a diaphragm coupled to a voice coil;
a magnet proximate to the diaphragm, the magnet having a first width at a first end and a second width at a second end, the first width larger than the second width; and
a surround coupled to the diaphragm, the surround having a stiffness varying along a length of the surround from a first stiffness proximate to the first end of the magnet to a second stiffness proximate to the second end of the magnet, the first stiffness greater than the second stiffness.

2. The apparatus of claim 1, wherein the surround has an arch cross-section coupling the diaphragm to a frame, where the arch has a different height at different locations along the length of the surround, a height of the arch at a location along the length of the surround based on a width of the magnet proximate to the location.

3. The apparatus of claim 2, wherein the height of the arch at the location on the length of the surround is inversely related to the width of the magnet proximate to the location.

4. The apparatus of claim 3, wherein a height of the arch of the surround proximate to the first end of the magnet is less than a height of the arch of the surround proximate to the second end of the magnet.

5. The apparatus of claim 2, wherein the height of the arch of the surround continuously changes between the first end of the magnet and the second end of the magnet.

6. The apparatus of claim 1, wherein the surround has an arch cross-section coupling the diaphragm to a frame, where the arch has a different width at different locations along the length of the surround, a width of the arch at a location along the length of the surround based on a width of the magnet proximate to the location.

7. The apparatus of claim 6, wherein the width of the arch of the surround continuously changes along the length of the surround between the first end of the magnet and the second end of the magnet.

8. The apparatus of claim 1, wherein the surround has different widths at different locations along a length of the surround between the first end of the magnet and the second end of the magnet.

9. The apparatus of claim 8, wherein a first width of the surround at a first end of the surround proximate to the first end of the magnet results in a maximum stiffness at the first end of the surround and a second width of the surround at a second end of the surround proximate to the second end of the magnet results in a minimum stiffness of the surround at the second end of the surround.

10. The apparatus of claim 1, wherein a stiffness at a location along the length of the surround is directly related to the width of the magnet proximate to the location.

11. The apparatus of claim 10, wherein the stiffness along the location of the surround continuously decreases from the first stiffness to the second stiffness along the length of the surround.

12. The apparatus of claim 1, wherein the diaphragm is configured to move in response to a magnetic field generated by the voice coil from a signal and a magnetic field of the magnet, a displacement of a portion of the diaphragm based on a magnetic field strength of a portion of the magnet proximate to the portion of the diaphragm and a stiffness of the surround proximate to the portion of the diaphragm.

13. The apparatus of claim 12, wherein stiffnesses of locations of the surround proximate to different portions of the diaphragm are configured so the displacement of portions of the diaphragm relative to the magnet is uniform across a length of the magnet.

14. The apparatus of claim 12, wherein stiffnesses of locations of the surround proximate to different portions of the diaphragm are configured so a first displacement relative to the magnet of portions of the diaphragm nearer to the first end of the magnet is greater than a second displacement relative to the magnet of positions of the diaphragm nearer to the second end of the magnet.

15. A headset comprising:
a frame;
one or more display elements coupled to the frame, each display element configured to generate image light; and
a speaker included in a portion of the frame, the speaker including:
a diaphragm coupled to a voice coil;
a magnet proximate to the diaphragm, the magnet having a first width at a first end and a second width at a second end, the first width larger than the second width; and
a surround coupled to the diaphragm and coupling the diaphragm to the portion of the frame, the surround having a stiffness varying along a length of the surround from a first stiffness proximate to the first end of the magnet to a second stiffness proximate to the second end of the magnet, the first stiffness greater than the second stiffness.

16. The headset of claim 15, wherein a stiffness at a location along the length of the surround is directly related to the width of the magnet proximate to the location.

17. The headset of claim 16, wherein the stiffness along the location of the surround continuously decreases from the first stiffness to the second stiffness along the length of the surround.

18. The headset of claim 15, wherein the surround has an arch cross-section coupling the diaphragm to a frame, where the arch has a different height at different locations along the length of the surround, a height of the arch at a location on the surround based on a width of the magnet proximate to the location.

19. The headset of claim 15, wherein the surround has an arch cross-section coupling the diaphragm to a frame, where the arch has a different width at different locations along the length of the surround, a width of the arch at a location on the surround based on a width of the magnet proximate to the location.

20. The headset of claim 15, wherein the portion of the frame comprises an end piece of the frame.
